(19) United States
(12) Patent Application Publication
(10) Pub. No.: US 2013/0136597 A1
(43) Pub. Date: May 30, 2013

(54) WIND TURBINE CONTROL SYSTEM

(71) Applicants: ULRICH VESTERGAARD B. HANSEN, Herning (DE); JANNIK HOEJGAARD, Brande (DK)

(72) Inventors: ULRICH VESTERGAARD B. HANSEN, Herning (DE); JANNIK HOEJGAARD, Brande (DK)

(21) Appl. No.: 13/667,176

(22) Filed: Nov. 2, 2012

(30) Foreign Application Priority Data
Nov. 30, 2011 (EP) 11191274.7

(51) Int. Cl. F03D 7/00

(52) U.S. Cl. 416/31

(57) ABSTRACT

A wind turbine control system is provided. The control system has a wind turbine controller arranged locally at the wind turbine and adapted to adjust operation parameters of the wind turbine, and a central control unit arranged remotely from the wind turbine and adapted to communicate with the controller. The central control unit has a module for virtualizing a first computing device and a second computing device. The first computing device monitors information provided by sensors of the wind turbine and received by the central control unit. The central control unit generates a control signal based on the received information and provides a control signal to the second computing device. The second computing device generates an adjusting signal based on the control signal to the wind turbine controller for controlling the operation of the wind turbine by adjusting operation parameters of the wind turbine.

### CROSS REFERENCE TO RELATED APPLICATIONS

This application claims priority of European Patent Office application No. 11191274.7 EP filed Nov. 30, 2011, which is incorporated by reference herein in its entirety.

### FIELD OF INVENTION

The present application relates to the field of wind parks. The application relates to a wind turbine control system. Further, the present application relates to a method for controlling an operation of a wind turbine. Moreover, the present application relates to a computer program that controls an operation of a wind turbine, which is adapted for performing the above mentioned method.

### BACKGROUND OF INVENTION

Wind turbines may be arranged in wind parks, wherein a plurality of wind turbines can be arranged in such a wind park. Each wind turbine comprises several hardware components for controlling the operation of the wind turbine. For example, a monitoring system may be arranged locally at the wind turbine for monitoring operation conditions of the wind turbine.

In the case of failures of the local hardware components, the hardware components have to be examined and eventually repaired most directly at the wind turbine. Use of physical hardware components being locally located may lead to a relatively high “mean time to repair” and “mean time to recover” and, at least most of the time, require a physical presence to the hardware.

There may be a need for providing a more efficient wind turbine control system, which is easier to handle.

### SUMMARY OF INVENTION

This need may be met by the subject matter according to the independent claims. Embodiments of the present application are described by the dependent claims.

According to a first aspect of the application, there is provided a wind turbine control system for controlling an operation of a wind turbine based on information provided by sensors of the wind turbine. The wind turbine control system comprises a wind turbine controller being arranged locally at the wind turbine and being adapted to adjust operation parameters of the wind turbine, and a central control unit being arranged remote from the wind turbine. The wind turbine controller and the central control unit are adapted to communicate with each other. The central control unit comprises a module for virtualizing a first computing device and a second computing device. The first computing device is adapted to monitor the information provided by the sensors of the wind turbine and received by the central control unit. The central control unit is adapted to generate a control signal based on information being provided by the first computing device and being indicative of the information provided by the sensors and is adapted to provide the control signal to the second computing device. The second computing device is adapted to generate an adjusting signal based on the control signal and is adapted to provide the adjusting signal to the wind turbine controller in order to control the operation of the wind turbine by adjusting the operation parameters of the wind turbine.

This aspect of the application is based on the idea to provide a centralized control system for the wind turbine, for example in an already existing central control unit. Components, which have been located locally at a wind turbine, may now be virtualized in the central control unit.

For this purpose, a first part of components of the control system of a wind turbine which are needed locally, as for example the sensors or the wind turbine controller, i.e. the direct control system of the wind turbine, may be still located locally at the wind turbine. “At” in this context may mean either in or inside the wind turbine or at least in close proximity, whereas the central control unit may be arranged remote, for example in a central control station.

In contrast to the first part of components, a second part of components of the control system, which are not necessarily needed locally at the wind turbine, may be removed from the wind turbine and may be arranged virtually in the central control unit.

For this purpose, the central control unit may comprise a module which is able to provide a virtual environment simulating physical parts of the wind turbine. According to this aspect of the application, the module virtualizes two computing devices of the wind turbine, i.e. a monitoring device and a control device. The monitoring device provides a monitoring system for monitoring the operation conditions of the wind turbine, inter alia by monitoring signals of sensors being arranged in units of the wind turbine. The control device provides an interface between the central control unit and the wind turbine controller.

The control device may be adapted, inter alia, to protect the wind turbine controller. For instance, communication may pass the control device (or control interface device) before it reaches the wind turbine controller. The control device, i.e. the second computing device may provide for example verification, intrusion protection, user management along with other sophisticated checks. The control device may further be used for storing measurement and actuators position of a predefined time period, for instance some weeks, with a given resolution and to calculate and communicate scientific and present values to the central control unit.

According to another embodiment, further physical components being arranged locally at the wind turbine may be virtualized by the module of the central control unit.

Operation parameters in this context may be for example the pitch angle of the blades, the yaw angle of the nacelle, the rotational speed of the rotor, or any other parameter being able to influence the operation of the wind turbine. The wind turbine controller may control the operation of the wind turbine directly by adjusting the operation parameters. Further, some information, like rotational speed, may be determined on the turbine controller.

The adjusting signal may for example comprise information being contained in the control signal and may be verified before being sent to the wind turbine controller. The wind turbine controller itself may then control the wind turbine based on the adjusting signal and determine new operation parameters for the wind turbine.

The control signal and also the adjusting signal may comprise information being determined by the monitoring unit. For example, the monitoring device may provide information in the form of operation messages comprising for instance status information or commands (start, stop).

The first computing (monitoring) device may be provided with input information or signals from the sensors of the wind turbine. This input information may comprise information about actual operation conditions, like wind speed, vibrations in the turbines main components.

The sensors may be connected via an analogue/digital converter and a network device to the monitoring device within the central control unit.

According to an embodiment of the application, the wind turbine control system comprises a further wind turbine controller being arranged locally at a further wind turbine and being adapted to adjust operation parameters of the wind turbine, wherein the further wind turbine controller and the central control unit are adapted to communicate with each other, wherein the central control unit comprises a further module for virtualizing a further first computing device and a further second computing device, wherein the further first computing device is adapted to monitor information provided by sensors of the further wind turbine and received by the central control unit, wherein the central control unit is adapted to generate a further control signal based on information being provided by the further first computing device and being indicative of the information provided by the sensors of the further wind turbine and is adapted to provide the control signal to the further second computing device, and wherein the further second computing device is adapted to generate an adjusting signal based on the further control signal and is adapted to provide the adjusting signal to the further wind turbine controller in order to control the operation of the further wind turbine by adjusting operation parameters of the further wind turbine.

The central control unit may comprise two or more, for example a plurality of, modules wherein each module comprises a first and a second computing device. Each module may be assigned to one of a plurality of wind turbine controllers, and to one of a plurality of wind turbines. Thus, one single central control unit may provide control functions for a plurality of wind turbines.

According to a further embodiment of the application, the central control unit is a supervisory control and data acquisition server.

The supervisory control and data acquisition server (SCADA) may refer to an industrial control system: a computer system monitoring and controlling a process, for example industrial processes like power generation, infrastructure processes like electrical power transmission and distribution, Wind Farms. The SCADA server may comprise the module for virtualizing the first and the second computing device.

According to a further embodiment of the application, the central control unit is coupled to the wind turbine controller and/or to the sensors of the wind turbine via a network device.

As part of the hardware components of the wind turbine are virtualized remote from the wind turbine, the central control unit may be connected to the network device via a redundant network connection, for example via redundant optical fibers. This may be necessary to ensure a reliable connection between the central control unit and the wind turbine controller.

According to a further embodiment of the application, the wind turbine controller comprises a safety module being adapted to be activated in the case of a failure of a connection between the central control unit and the wind turbine controller.

According to this embodiment, the wind turbine controller may be provided with a safe-mode module or program which may be activated in the case of any failure of the connection between the central control unit and the wind turbine controller, inter alia loss of connection due to electricity failure or any other event leading to a loss of the connection. As parts of the control functions of the wind turbine are located and virtualized in the central control unit remote from the wind turbine, it might have to be ensured that in the case of a failure, for example in the case of a failure of the network connection, the wind turbine is controlled according to a predefined safe-mode.

According to a further embodiment of the application, a failure of the central control unit comprises a failure of the central control unit and/or a loss of power supply.

A failure of the connection may occur for example due to a blackout or electricity failure of the connection between the central control unit and the wind turbine controller or a failure of the central control unit itself (which may also be caused by an electricity failure).

According to a further embodiment of the application, the wind turbine controller comprises a monitoring computing device being adapted to monitor the connection between the central control unit and the wind turbine controller and to activate the safety module.

A failure of the connection may be determined for instance when the network connection is lost for a predefined time period. The safety module may be activated and may set the wind turbine controller to a safe-mode.

According to a further embodiment of the application, the safety module is adapted to adjust the operation parameters of the wind turbine such that the rotational speed of the rotor is equal or less than a predefined rotational speed.

The operation parameters may be adjusted such that the rotational speed of the rotor of the wind turbine does not exceed a maximum allowed rotational speed in the safe mode situation. For example, the wind turbine controller may control the operation of the wind turbine according to stored operation parameters for a safety mode.

According to a further embodiment of the application, the operation parameters comprises at least one of a pitch angle of the blades of the wind turbine or a yaw angle of the nacelle of the wind turbine. In one embodiment, all three pitch angle values of the blades along with the yaw angle of the nacelle may be stored.

The safe-mode module or program in the wind turbine controller may set the pitch angle of the blades and/or the yaw angle of the nacelle in such a way that the rotational speed of the rotor of the wind turbine does not exceed a maximum allowed rotational speed as defined for a safe mode situation.

According to a further embodiment of the application, the safety module is adapted to adjust the operation parameters based on values stored in database which is stored in the wind turbine controller and based on information provided by the sensors before the failure.

For example, in situations with high wind speed measured before the failure, the safe-mode module or program may set the pitch angle and/or yaw angle or any other operation parameter according to values from a data base, for example a look-up table, in dependency of the measured wind speed, provided by the sensors, which was sent to the turbine controller from the second device of the central control unit before the failure. In this way the rotor may be stopped or the rotational speed of the rotor may be reduced depending on the look-up table values for the pitch angle and/or yaw angle or any other operation parameter.

According to a further aspect of the application, it is provided a wind park arrangement comprising a plurality of wind turbines, and a wind turbine control system as described above for controlling an operation of the plurality of wind turbines.

Thus, one single central control unit may control a plurality of wind turbines.

According to a further aspect of the application, it is provided a method for controlling an operation of a wind turbine by a wind turbine control system based on information provided by sensors of the wind turbine. The wind turbine control system comprises a wind turbine controller being arranged locally at the wind turbine and being adapted to adjust operation parameters of the wind turbine, and a central control unit being arranged remote from the wind turbine. The wind turbine controller and the central control unit are adapted to communicate with each other. The method comprises virtualizing, by a module of the central control unit, a first computing device and a second computing device, monitoring, by the first computing device, the information provided by the sensors of the wind turbine and received by the central control unit. The method comprises further generating, by the central control unit, a control signal based on information being provided by the first computing device and being indicative of the information provided by the sensors and providing the control signal to the second computing device, and generating, by the second computing device, an adjusting signal based on the control signal and providing the adjusting signal to the wind turbine controller in order to control the operation of the wind turbine by adjusting the operation parameters of the wind turbine.

According to a further aspect of the application, there is provided a computer program for controlling an operation of a wind turbine, the computer program, when being executed by a data processor, is adapted for controlling the method having the above mentioned features.

As used herein, reference to a computer program is intended to be equivalent to a reference to a program element and/or to a computer readable medium containing instructions for controlling a computer system to coordinate the performance of the above described method.

The application may be realized by a computer program respectively software. However, the application may also be realized by one or more specific electronic circuits respectively hardware. Furthermore, the application may also be realized in a hybrid form, i.e. in a combination of software modules and hardware modules.

It has to be noted that embodiments of the application have been described with reference to different subject matters. Some embodiments have been described with reference to method type claims whereas other embodiments have been described with reference to apparatus type claims. However, a person skilled in the art will gather from the above and the following description that, unless other notified, in addition to any combination of features belonging to one type of subject matter also any combination between features relating to different subject matters, such as between features of the method type claims and features of the apparatus type claims is considered as to be disclosed with this document.

### BRIEF DESCRIPTION OF THE DRAWINGS

The aspects defined above and further aspects of the present application are apparent from the examples of embodiment to be described hereinafter and are explained with reference to the examples of embodiment. The application will be described in more detail hereinafter with reference to examples of embodiment but to which the application is not limited.

FIG. 1 shows a wind turbine control system according to an embodiment of the application.

FIG. 2 shows a conventional wind turbine control system.

FIG. 3 shows a wind turbine control system according to a further embodiment of the application.

### DETAILED DESCRIPTION OF INVENTION

The application is schematically illustrated in the drawings. It is noted that in different figures, similar or identical elements are provided with the same reference signs.

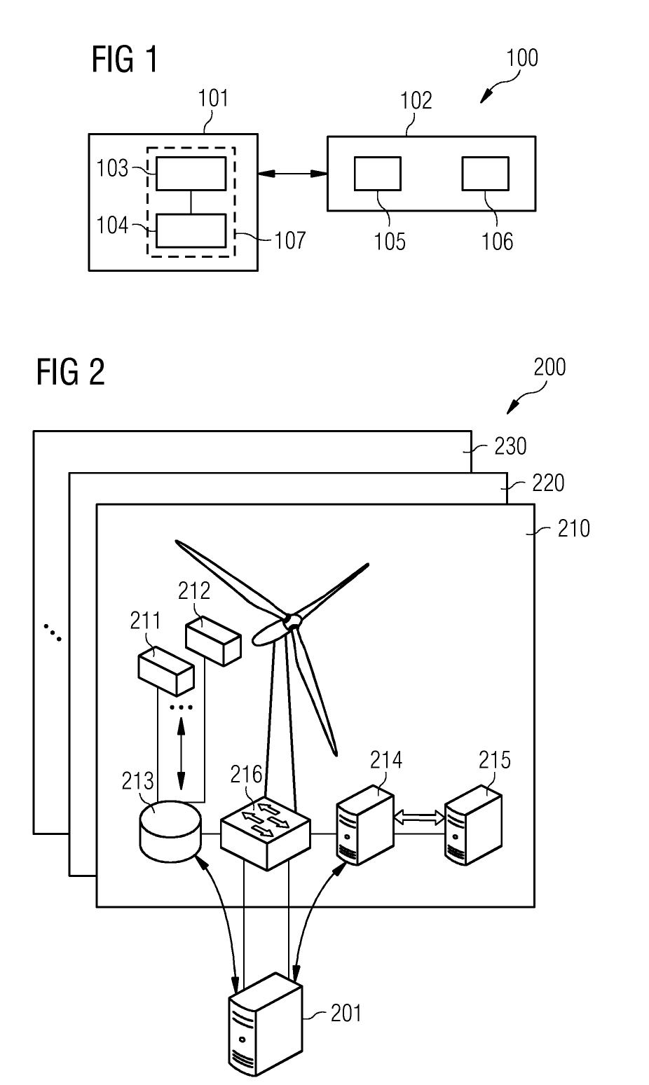

FIG. 1 shows a wind turbine control system 100 according to an embodiment of the application. The wind turbine control system comprises a wind turbine controller 105 being arranged locally at a wind turbine 102 and being adapted to adjust operation parameters of the wind turbine. The wind turbine control system comprises further a central control unit 101 being arranged remote from the wind turbine. The wind turbine controller and the central control unit are adapted to communicate with each other. The central control unit comprises a module 107 for virtualizing a first computing device 103 and a second computing device 104. The first computing device is adapted to monitor information. The information is provided by sensors 106 of the wind turbine and is received by the central control unit. The central control unit is adapted to generate a control signal based on information being provided by the first computing device and being indicative of the information provided by the sensors and is adapted to provide the control signal to the second computing device. The second computing device is adapted to generate an adjusting signal based on the control signal and is adapted to provide the adjusting signal to the wind turbine controller in order to control the operation of the wind turbine by adjusting the operation parameters of the wind turbine.

In common wind turbine control systems, as for example shown in FIG. 2, each wind turbine 210, 220, 230 has a set of hardware based solutions to control and operate the wind turbine. A wind turbine comprises a wind turbine controller 215 which is coupled via an interface system 214 to a central control unit 201. The central control unit is arranged outside or remote from the wind turbine. The wind turbine comprises further a monitoring system 213 for monitoring operation conditions via sensors 211, 212. The monitoring system is also coupled to the central control unit. For coupling the physical components of the wind turbine to the central control unit, the wind turbine comprises a network device 216, for instance an Ethernet switch.

In a system as shown in FIG. 2, if new functionality is required, a new piece of hardware is typically deployed in the wind turbines. This can be for example IP-to-Serial converters or industrial grade PC's that serves a certain purpose. This may be an expensive solution due to the fact that it is difficult as well as expensive to make hardware upgrades/replacements in the turbine. During maintenance and troubleshooting, it may require expensive physical presence in the turbine. As physical hardware is used “Mean Time To Repair” and “Mean Time To Recover” are also relatively high and most often requires physical presence to the hardware.

Thus, according to the present application, part of the control system may be taken out of the physical wind turbine, and may be virtualized into one secure, scalable and reliable system, which could be in a control room facility/substation. By virtualizing the physical control system instances inside control room facility/substation, it may be possible to eliminate expensive hardware upgrades and/or replacements. Also due to virtualization of the control system components from each turbine, physical presence in each turbine might not be required.

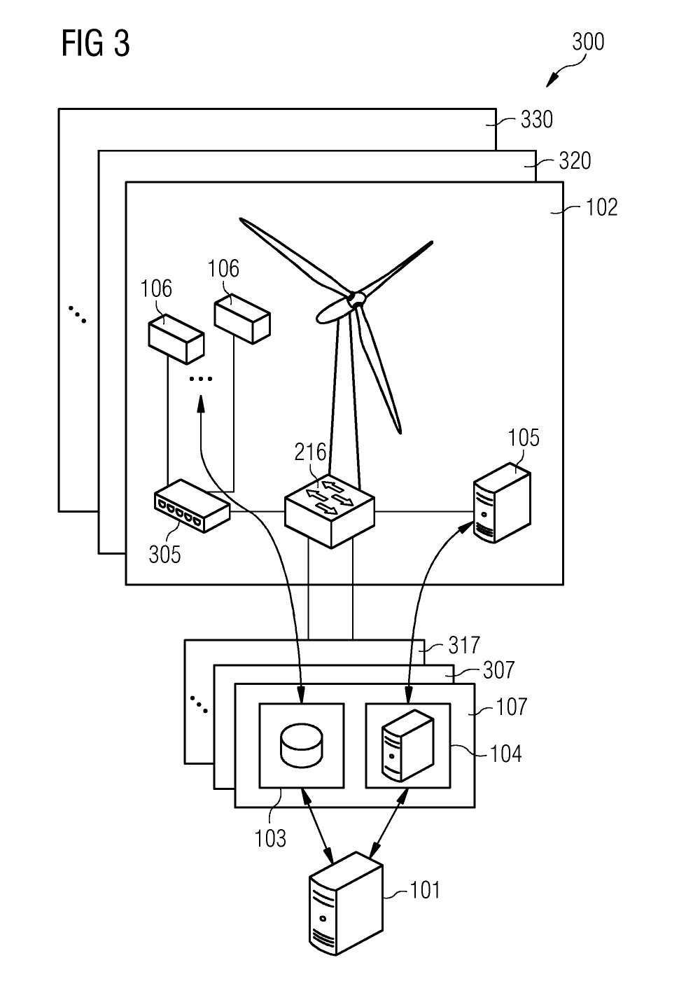

As shown in FIG. 3, in the case of a virtualized control system, the turbine control instances can be virtualized in the control room facility/substation, which makes controlling, monitoring, troubleshooting, and maintenance easier. The wind turbine control system 300 comprises a central control unit 101 comprising a module 107, 307, 317 for each wind turbine 102, 320, 330 being coupled to the central control unit. Each module comprises a first computing device 103 for monitoring the sensor outputs of the associated wind turbine and a second computing device 104 for providing an interface to the wind turbine controller 105 of the associated wind turbine.

The wind turbine controller is still arranged locally at the wind turbine and is coupled via a network device 216 to the central control unit. The sensors are coupled to the module 107 via the central control unit by using the network device. The sensors are coupled to the network device via an Analogue/Digital (A/D) converter 305.

As the wind turbine control system is extended outside of the wind turbine it may be supported by redundant and passive fiber optical infrastructure as well as a redundant and active network infrastructure to ensure the connection between the central control unit and the wind turbines. In an embodiment the wind turbine controller in each wind turbine may be provided with a safe-mode module or program which may be activated if the network to the SCADA facility/substation (central control unit) should be lost in a time period. The safe-mode module or program may set the pitch angle of the blades and/or the yaw angle of the nacelle in such a way that the rotational speed of the rotor of the wind turbine does not exceed a maximum allowed rotational speed in a safe mode situation. In situations with high wind speed measured before the network failure, the safe-mode module or program may set the pitch angle and/or yaw angle according to values from a look-up table in dependency of the measured wind speed which was sent to the wind turbine controller from the SCADA substation before the network communication was lost. In this way the rotor may be stopped or the rotational speed of the rotor may be reduced depending on the look-up table values for the pitch angle and/or yaw angle.

By using the described control system, the following aspects may be achieved. The system hardware may be easy and inexpensive to upgrade for future requirements as only one system needs to be upgraded instead of replacing/updating the hardware in all of the wind turbines. There may be a potential large cost reduction of the control system as part of the control system is virtualized and located in a central location. Commissioning may be faster and easier as the control system can be configured in a central location by configuration specialists and are not dependant on the wind turbine being erected and energized. The required space may be reduced in control cabinets in the wind turbine as the hardware may be a virtualized part of the control system, virtualized centrally in a substation. Less configuration of end-devices in the wind turbines might be required. The control system can be simply made redundant. A reduced MTTR (Mean time to recovery) may be achieved in case of errors as it does not require physical access to the wind turbine. MTBF (mean time between failure) may be improved as only one high availability platform is used which is designed to be “always up”. The security platform may be improved as it's much easier and less risky to manage security related updates on virtualized environments as they can easily be rolled back to a previously working configuration. Professional and tested technology may be used which is being used in many enterprise environments. Visits to turbines for maintenance may be reduced as only one substation needs to be accessed where the equipment is located. This may also reduce time to repair in case of errors as not every wind turbine needs to be visited. A remote support may be performed, also for maintenance. A reduction of stock value may be achieved as it might be no further required to hold stock the hardware. Also a reduction of wind turbine price may be achieved as expensive hardware might be not needed for every wind turbine, but only one larger system to accommodate the virtualized control system. There might be no hardware dependence on specific versions of hardware. It may be easier to make mass changes to the system.

It should be noted that the term “comprising” does not exclude other elements or steps and the use of articles “a” or “an” does not exclude a plurality. Also elements described in association with different embodiments may be combined. It should also be noted that reference signs in the claims should not be construed as limiting the scope of the claims.

1. A wind turbine control system for controlling an operation of a wind turbine, comprising:
a plurality of sensors arranged on the wind turbine;
a wind turbine controller being arranged locally at the wind turbine and being adapted to adjust operation parameters of the wind turbine; and
a central control unit being arranged remotely from the wind turbine,
wherein the wind turbine controller and the central control unit are adapted to communicate with each other,
wherein the central control unit comprises a module for virtualizing a first computing device and a second computing device,
wherein the first computing device is adapted to monitor information provided by the sensors of the wind turbine and received by the central control unit,
wherein the central control unit is adapted to generate a control signal based on the received information and to provide the control signal to the second computing device, and
wherein the second computing device is adapted to generate an adjusting signal based on the control signal and to provide the adjusting signal to the wind turbine controller for controlling the operation of the wind turbine by adjusting the operation parameters of the wind turbine according to the adjusting signal.

2. The wind turbine control system as claimed in claim 1, further comprising a further wind turbine controller being arranged locally at a further wind turbine and being adapted to adjust operation parameters of the further wind turbine,
wherein the further wind turbine controller and the central control unit are adapted to communicate with each other,
wherein the central control unit comprises a further module for virtualizing a further first computing device and a further second computing device,
wherein the further first computing device is adapted to monitor further information provided by further sensors arranged on the further wind turbine and received by the central control unit,
wherein the central control unit is adapted to generate a further control signal based on the received further information and to provide the further control signal to the further second computing device, and
wherein the further second computing device is adapted to generate a further adjusting signal based on the further control signal and to provide the further adjusting signal to the further wind turbine controller for controlling an operation of the further wind turbine by adjusting the operation parameters of the further wind turbine according to the further adjusting signal.

3. The wind turbine control system as claimed in claim 1, wherein the central control unit is a supervisory control and data acquisition server.

4. The wind turbine control system as claimed in claim 1, wherein the central control unit is coupled to the wind turbine controller and/or to the sensors of the wind turbine via a network device.

5. The wind turbine control system as claimed in claim 1, wherein the wind turbine controller comprises a safety module being adapted to be activated when a failure of a connection between the central control unit and the wind turbine controller occurs.

6. The wind turbine control system as claimed in claim 5, wherein the failure of the connection between the central control unit and the wind turbine controller comprises a failure of the central control unit and/or a loss of power supply.

7. The wind turbine control system as claimed in claim 6, wherein the wind turbine controller comprises a monitoring computing device being adapted to monitor the connection between the central control unit and the wind turbine controller and to activate a safety module.

8. The wind turbine control system as claimed in claim 7, wherein the safety module is adapted to adjust the operation parameters of the wind turbine so that a rotational speed of a rotor of the wind turbine is equal or less than a predefined rotational speed.

9. The wind turbine control system as claimed in claim 7, wherein the safety module is adapted to adjust the operation parameters of the wind turbine based on values stored in a database in the wind turbine controller and the information provided by the sensors before the failure.

10. The wind turbine control system as claimed in claim 1, wherein the operation parameters comprise a pitch angle of a blade of the wind turbine or a yaw angle of a nacelle of the wind turbine.

11. A wind park arrangement, comprising:
a plurality of wind turbines; and
a wind turbine control system as claimed in claim 1.

12. A method for controlling an operation of a wind turbine by a wind turbine control system, comprising:
locally arranging a wind turbine controller at the wind turbine;
remotely arranging a central control unit from the wind turbine, wherein the wind turbine controller and the central control unit are adapted to communicate with each other;
virtualizing a first computing device and a second computing device by a module of the central control unit;
monitoring information provided by sensors arranged on the wind turbine and received by the central control unit by the first computing device;
generating a control signal based on the received information by the central control unit;
providing the control signal to the second computing device by the central control unit;
generating an adjusting signal based on the control signal by the second computing device; and
providing the adjusting signal to the wind turbine controller by the second computing device for controlling the operation of the wind turbine by adjusting operation parameters of the wind turbine according to the adjusting signal.
